(19) United States
(12) Patent Application Publication
(10) Pub. No.: US 2019/0058961 A1
(43) Pub. Date: Feb. 21, 2019

(54) SYSTEM AND PROGRAM FOR IMPLEMENTING THREE-DIMENSIONAL AUGMENTED REALITY SOUND BASED ON REALISTIC SOUND

(71) Applicant: LIKERS GAME CO., LTD., Seoul (KR)

(72) Inventor: Seung Hak LEE, Yongin-si (KR)

(73) Assignee: LIKERS GAME CO., LTD., Seoul (KR)

(21) Appl. No.: 16/168,560

(22) Filed: Oct. 23, 2018

Related U.S. Application Data
(63) Continuation of application No. PCT/KR2018/003189, filed on Mar. 19, 2018.

(30) Foreign Application Priority Data
Mar. 20, 2017 (KR) 10-2017-0034398
Aug. 14, 2017 (KR) 10-2017-0102892
Sep. 11, 2017 (KR) 10-2017-0115842

(51) Int. Cl. H04S 5/00; H04S 7/00; H04R 5/04; H04R 3/00; H04R 5/033

(52) U.S. Cl. CPC H04S 5/005; H04S 7/304; H04S 2400/15; H04R 3/005; H04R 5/033; H04R 5/04

(57) ABSTRACT

Disclosed is an augmented reality sound implementation system for executing an augmented reality sound implementation method. The system includes a first computing device of a first user; and a first sound device which is worn by the first user so that the first user can receive a three-dimensional augmented reality sound, is connected to the first computing device in a wired or wireless manner, and includes a sound recording function.

### CROSS-REFERENCE TO RELATED APPLICATIONS

The present application is a continuation of International Patent Application No. PCT/KR2018/003189 filed Mar. 19, 2018, which is based upon and claims the benefit of priority to Korean Patent Application Nos. 10-2017-0034398 filed Mar. 20, 2017, 10-2017-0102892 filed Aug. 14, 2017 and 10-2017-0115842 filed Sep. 11, 2017. The disclosures of the above-listed applications are hereby incorporated by reference herein in their entirety.

### BACKGROUND

Embodiments of the inventive concept described herein relate to a system and a program for implementing three-dimensional augmented reality sound based on realistic sound.

The augmented reality refers to, but is not limited to, a computer graphic technology that displays one image obtained by mixing a real-world image that a user sees and a virtual image, and thus also refers to the real-virtual image blending technology used in mixed reality. The augmented reality may be obtained by composing images of virtual objects or information and specific objects of real world images.

The three-dimensional sound refers to a technology that provides three-dimensional sound such that the user can feel the sense of presence. In the virtual reality field, a three-dimensional sound is implemented by providing a sound depending on the path transmitted from the sound generating location to the user by using the vector value of the virtual reality image.

However, it is difficult to use a method for implementing three-dimensional augmented reality sound based on realistic sound, in that the direction of the realistic sound cannot be grasped in advance and must be grasped in real time in augmented reality.

For example, the location of another user may not be intuitively predicted because sound is ringing when a plurality of users are placed inside the building in the virtual reality.

Accordingly, a method and a program capable of implementing the three-dimensional sound based on real-time realistic sound are required in augmented reality fields.

### SUMMARY

The inventive concept provides a system and a program for implementing a three-dimensional augmented reality sound based on realistic sound.

The technical objects of the inventive concept are not limited to the above-mentioned ones, and the other unmentioned technical objects will become apparent to those skilled in the art from the following description.

In accordance with an aspect of the inventive concept, there is provided an augmented reality sound implementation system for performing a method for an augmented reality sound, the system comprises a first computing device of a first user; and a first sound device which is worn by the first user such that the first user can receive a three-dimensional augmented reality sound, is connected to the first computing device in a wired or wireless manner, and includes a sound recording function, wherein the method comprises obtaining, by the first sound device, realistic sound information, which indicates a realistic sound, to transmit the realistic sound information to the first computing device; obtaining, by the first computing device, a first virtual sound which indicates a sound generated from a virtual reality game executed by the first computing device; generating, by the first computing device, a three-dimensional augmented reality sound based on the realistic sound information and the first virtual sound; and providing, by the first computing device, the three-dimensional augmented reality sound to the first user through the first sound device.

The other detailed items of the inventive concept are described and illustrated in the specification and the drawings.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a conceptual diagram for describing a method for implementing augmented reality sound;

FIG. 2 is a block diagram illustrating a device for implementing augmented reality sound;

FIG. 3 is a flowchart illustrating a first embodiment of a method for implementing augmented reality sound; and

FIG. 4 is a flowchart illustrating a second embodiment of a method for implementing augmented reality sound.

### DETAILED DESCRIPTION

The above and other aspects, features and advantages of the invention will become apparent from the following description of the following embodiments given in conjunction with the accompanying drawings. However, the inventive concept is not limited to the embodiments disclosed below, but may be implemented in various forms. The embodiments of the inventive concept are provided to make the disclosure of the inventive concept complete and fully inform those skilled in the art to which the inventive concept pertains of the scope of the inventive concept.

The terms used herein are provided to describe the embodiments but not to limit the inventive concept. In the specification, the singular forms include plural forms unless particularly mentioned. The terms “comprises” and/or “comprising” used herein does not exclude presence or addition of one or more other elements, in addition to the aforementioned elements. Throughout the specification, the same reference numerals dente the same elements, and “and/or” includes the respective elements and all combinations of the elements. Although “first”, “second” and the like are used to describe various elements, the elements are not limited by the terms. The terms are used simply to distinguish one element from other elements. Accordingly, it is apparent that a first element mentioned in the following may be a second element without departing from the spirit of the inventive concept.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Hereinafter, exemplary embodiments of the inventive concept will be described in detail with reference to the accompanying drawings.

According to an embodiment of the present disclosure, a method for implementing three-dimensional augmented reality sound based on realistic sound may be implemented by a computing device 200. The method for implementing augmented reality sound may be implemented with an application, may be stored in the computing device 200, and may be performed by the computing device 200.

For example, the computing device 200 may be provided as, but not limited to, a mobile device such as a smartphone, a tablet PC, or the like and only needs to be equipped with a camera, output sound, and process and store data. That is, the computing device 200 may be provided as a wearable device, which is equipped with a camera and outputs sound, such as a glasses, a band, or the like. The arbitrary computing device 200 not illustrated may be provided.

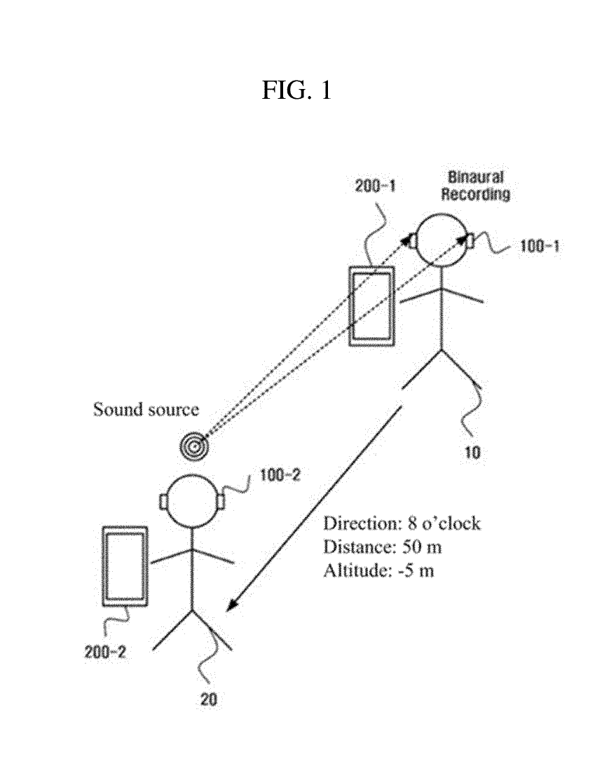

FIG. 1 is a conceptual diagram for describing a method for implementing augmented reality sound.

Referring to FIG. 1, the plurality of users 10 and 20 carry sound devices 100-1 and 100-2 and computing devices 200-1 and 200-2 and experience augmented reality content. In an embodiment, only the two users 10 and 20 are illustrated. However, an embodiment is not limited thereto. For example, the method for implementing augmented reality sound may be substantially identically applied to an environment in which there are two or more users.

For example, a sound device 100 may be provided in the form of a headphone, a headset, an earphone, or the like. The sound device 100 may include a speaker so as to output sound; in addition, the sound device 100 may include a microphone so as to obtain and record the surrounding sound. The sound device 100 may be provided in the binaural type for the purpose of enhancing the sense of presence. The sound including direction feature information may be obtained by recording the left sound and the right sound separately, using a binaural effect. In some embodiments, the sound device 100 may be a separate device as the sound output device and the sound recording device.

The sound device 100 may obtain realistic sound information generated by the users 10 and 20. Alternatively, the sound device 100 may obtain the realistic sound information generated at a periphery of the users 10 and 20. That is, a sound source may be placed at a location where the realistic sound is generated. The sound source may not be limited to the sound generated by the plurality of users 10 and 20.

Herein, the realistic sound information may indicate actual sound information generated in real life. For example, when the second user 20 makes a sound to the first user 10 while playing an augmented reality game, the first sound device 100-1 of the first user 10 may obtain the realistic sound information (sound) generated from the second user 20. Herein, the second user 20 may be a user located at a place space apart from the first user 10.

The first sound device 100-1 of the first user 10 may also obtain direction feature information of the realistic sound generated by the second user 20 together. The first computing device 200-1 of the first user 10 may synthesize the realistic sound information of the first user 10 and first virtual sound information indicating sound (e.g., background sound, effect sound, or the like) generated in a virtual reality game, based on the direction feature information of the realistic sound obtained from the first sound device 100-1 to generate three-dimensional augmented reality sound for the first user 10.

When the sound device 100 does not support the binaural type of sound or when a distance between the first user 10 and the second user 20 is longer than a predetermined distance, the first computing device 200-1 may obtain the direction feature information of the realistic sound based on information about the relative location of the first user 10 and the second user 20.

The plurality of computing devices 200-1 and 200-2 or a server may obtain the locations of the first user 10 and the second user 20 and may compare the locations of each other to generate relative location information. For example, a well-known positioning system including a GPS system may be used to obtain the locations of the plurality of users 10 and 20. The plurality of computing devices 200-1 and 200-2 or the server may obtain three-dimensional locations of the first user 10 and the second user 20 and may compare the three-dimensional locations of each other to generate relative three-dimensional location information.

For example, as illustrated in FIG. 1, the relative location information indicating that the second user 20 is located in a direction of 8 o′clock, at a distance of 50 m, and at a low altitude of 5 m with respect to the first user 10 may be generated. Herein, the second user 20 may generate the realistic sound.

In addition, the direction feature information of the realistic sound obtained by the first user 10 is determined based on the relative location information. The three-dimensional augmented reality sound for the first user 10 may be implemented by synthesizing the realistic sound information obtained from the second user 20 by the first user 10, the direction feature information of the realistic sound, and the first virtual sound information. The element such as amplitude, a phase, a frequency, or the like of the realistic sound may be adjusted depending on the determined direction feature information of the realistic sound.

The method for implementing augmented reality sound according to an embodiment of the present disclosure may use the binaural type of the sound device 100 or the relative location information of the plurality of users 10 and 20, and thus may implement the three-dimensional augmented reality sound based on the real-time realistic sound.

According to an embodiment, the above-described binaural type of the sound device 100 and the relative location information of the first user 10 and the second user 20 may be used together.

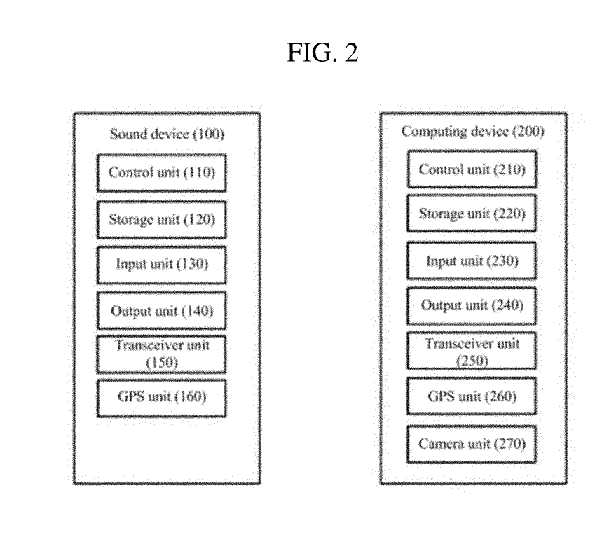

FIG. 2 is a block diagram illustrating a device for implementing augmented reality sound.

Referring to FIG. 2, the sound device 100 may include at least one control unit 110, a storage unit 120, an input unit 130, an output unit 140, a transceiver unit 150, and a GPS unit 160.

Each of the components included in the sound device 100 may be connected by a bus so as to communicate with one another.

The control unit 110 may execute a program command stored in the storage unit 120. The control unit 110 may indicate a central processing unit (CPU), a graphic processing unit (GPU), or a dedicated processor that performs methods according to an embodiment of the present disclosure.

The storage unit 120 may be implemented with at least one of a volatile storage medium and a nonvolatile storage medium. For example, the storage unit 120 may be implemented with at least one of a read only memory (ROM) and a random access memory (RAM).

The input unit 130 may be a recording device capable of recognizing and recording a voice. For example, the input unit 130 may be a microphone, or the like. The output unit 140 may be an output device capable of outputting a voice. The output device may include a speaker, or the like.

The transceiver unit 150 may be connected to the computing device 200 or a server so as to perform communication. The GPS unit 160 may track the location of the sound device 100.

The computing device 200 may include at least one control unit 210, a storage unit 220, an input unit 230, an output unit 240, a transceiver unit 250, a GPS unit 260, a camera unit 270, and the like.

Each of the components included in the computing device 200 may be connected by a bus so as to communicate with one another. The output unit 240 may be an output device capable of outputting a screen. The output device may include a display, or the like.

The control unit 210 may execute a program command stored in the storage unit 220. The control unit 210 may indicate a CPU, a GPU, or a dedicated processor that performs methods according to an embodiment of the present disclosure. The storage unit 220 may be implemented with at least one of a volatile storage medium and a nonvolatile storage medium. For example, the storage unit 220 may be implemented with at least one of a ROM and a RAM.

The transceiver unit 250 may be connected to the other computing device 200, the sound device 100, or the server so as to perform communication. The GPS unit 260 may track the location of the computing device 200. The camera unit 270 may obtain a reality image.

In some embodiments, the method for implementing augmented reality sound may be implemented by linking the computing device to another computing device or a server.

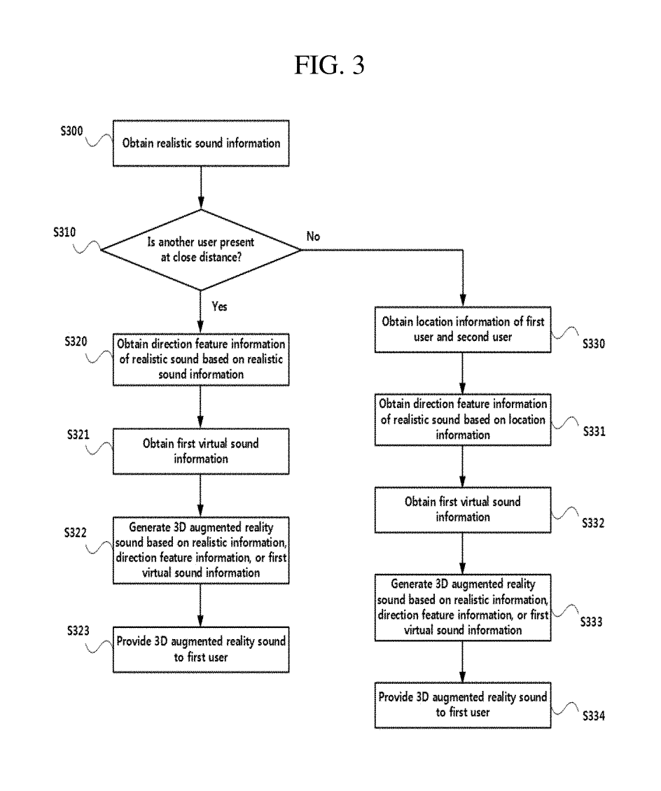

FIG. 3 is a flowchart illustrating a first embodiment of a method for implementing augmented reality sound.

Referring to FIG. 3, the first sound device 100-1 of the first user 10 may obtain realistic sound information. Herein, the realistic sound information may be the realistic sound generated from the second user 20 or the realistic sound generated at the first user 10.

The first sound device 100-1 may transmit realistic sound information to the first computing device 200-1 of the first user 10. In operation S300, the first computing device 200-1 may obtain the realistic sound information from the first sound device 100-1.

In operation S310, the first computing device 200-1 may determine whether another user (e.g., the second user 20) is present at a distance closed to the first user 10. The close distance may be a predetermined distance.

When the first user 10 and the second user 20 are closer to each other than the predetermined distance, in operation S320, the first computing device 200-1 may obtain direction feature information of the realistic sound, based on the realistic sound information. Herein, the realistic sound information may be the binaural type of sound information measured by the plurality of input units 130 of the first sound device 100-1.

In operation S321, the first computing device 200-1 may obtain first virtual sound information indicating sound generated in a virtual reality game.

In operation S322, the first computing device 200-1 may generate three-dimensional augmented reality sound based on at least one of the realistic sound information, the direction feature information, or the first virtual sound information. In particular, the first computing device 200-1 may generate the three-dimensional augmented reality sound by blending at least one information of the realistic sound information, the direction feature information, or the first virtual sound information.

For example, when the first user 10 has obtained the sound source of the first verse of the national anthem saying that “Until the East Sea's waters and Baekdu Mountain are dry and worn away, God protects and helps us. May our nation be eternal” from the north side of the first user 10, the first computing device 200-1 may generate the three-dimensional augmented reality sound by blending the direction feature information, the realistic sound information, and the first virtual sound information indicating sound generated in the virtual reality game such that the first user 10 can hear the corresponding sound source as if the corresponding sound source has been originated from the north.

In operation S323, the first computing device 200-1 may provide the three-dimensional augmented reality sound to the first user 10 through the first sound device 100-1.

When the first user 10 and the second user 20 are not closer to each other than a predetermined distance, in operation S330, the second computing device 200-2 may obtain location information of the first user 10 and the second user 20.

In operation S331, the first computing device 200-1 may obtain direction feature information of the realistic sound, based on location information of the first user 10 and the second user 20. In operation S332, the first computing device 200-1 may obtain first virtual sound information indicating sound generated in a virtual reality game.

In operation S333, the first computing device 200-1 may generate three-dimensional augmented reality sound based on at least one of the realistic sound information, the direction feature information, or the first virtual sound information. In particular, the first computing device 200-1 may generate the three-dimensional augmented reality sound by blending at least two or more information of the realistic sound information, the direction feature information, or the first virtual sound information.

For example, when the sound source of the first verse of the national anthem saying that “Until the East Sea's waters and Baekdu Mountain are dry and worn away, God protects and helps us. May our nation be eternal” is generated from the second user 20, the first computing device 200-1 may generate the three-dimensional augmented reality sound in consideration of the direction feature information such that the first user 10 located at the right side of the second user 20 can hear the corresponding sound source as if the corresponding sound source has been originated from the left side.

In operation S334, the first computing device 200-1 may provide the three-dimensional augmented reality sound to the first user 10 through the first sound device 100-1.

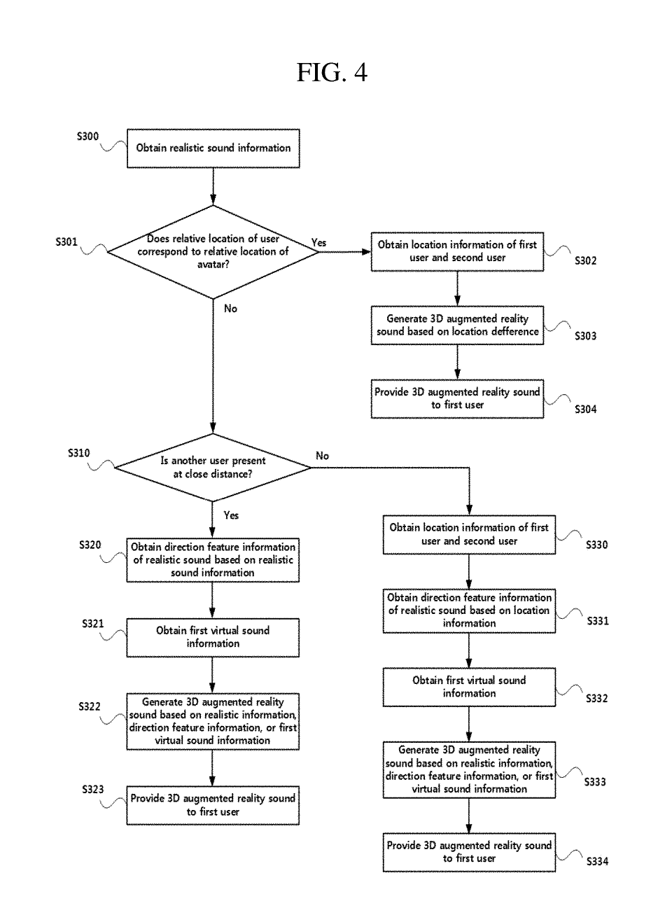

FIG. 4 is a flowchart illustrating a second embodiment of a method for implementing augmented reality sound.

Referring to FIG. 4, the first sound device 100-1 of the first user 10 may obtain realistic sound information. Herein, the realistic sound information may be the realistic sound generated from the first user 10 or the realistic sound generated at the first user 10.

The first sound device 100-1 may transmit the realistic sound information to the first computing device 200-1 of the first user 10. In operation S300, the first computing device 200-1 may obtain the realistic sound information from the first sound device 100-1.

In operation S301, the first computing device 200-1 may determine whether a location difference in which the relative location of the plurality of users 10 and 20 in a reality space corresponds to the relative location of avatars of the plurality of users 10 and 20 in a virtual space of an augmented reality game.

The location difference may be the case where the second user 20 utilizes a skill to the first user 10 and may be the case where the second user 20 and the avatar of the second user 20 are divided. The detailed example of the case where the avatar is divided may be as follows. The second user 20 may utilize the skill to the first user 10. In this case, after being divided, the avatar of the second user 20 may move to the avatar of the first user 10 and then may utilize the skill.

In addition, the location difference may be the case where the second user 20 utilizes the skill and may be the case where the avatar of the second user 20 teleports. Generally, teleportation may be referred to as “teleport” in a game. The teleportation (or teleport) may mean that anyone moves to any space momentarily. Usually, the teleportation may be used when anyone moves to very distant places.

For example, while being located at the east side of the avatar of the first user 10, the avatar of the second user 20 teleports and then is located at the west side of the avatar of the first user 10. In this case, the first computing device 200-1 may generate three-dimensional augmented reality sound in consideration of the difference between the location of the avatar of the second user 20 and the location of the second user 20.

Furthermore, the location difference may be the case where the second user 20 utilizes the skill to the first user 10 and may be the case where the movement of the avatar of the second user 20 is greater or shorter than the movement of the second user 20.

For example, the case where the movement of the avatar of the second user 20 is greater or shorter than the movement of the second user 20 may be the case where the second user 20 is moving faster because the second user 20 utilizes the skill. In this case, the first computing device 200-1 may consider the sound generated while the avatar of the second user 20 moves rapidly.

When the location difference occurs, in operation S302, the first computing device 200-1 may obtain location information of the first user 10 and the second user 20. In operation S303, the first computing device 200-1 may generate the three-dimensional augmented reality sound based on the location difference.

When the location difference occurs, the first computing device 200-1 may generate the three-dimensional augmented reality sound through blending the realistic sound and the second virtual sound generated to correspond to the locations of avatars of the plurality of users 10 and 20. When the first user 10 or the second user 20 utilizes the skill, the first computing device 200-1 may perform sound blending so as to fit the first-person situation or the third-person situation.

For example, when the location of the avatar of the first user 10 or the second user 20 is changed because the first user 10 or the second user 20 utilizes the skill while playing a game in the first-person situation, the first computing device 200-1 may generate virtual sound so as to fit the third-person situation and then may blend the realistic sound and the generated virtual sound.

In operation S304, the first computing device 200-1 may provide the three-dimensional augmented reality sound to the first user through the first sound device 100-1.

When the location difference does not occur, in operation S310, the first computing device 200-1 may determine whether another user (e.g., the second user 20) is present at a distance closed to the first user 10. The close distance may be a predetermined distance.

When the first user 10 and the second user 20 are closer to each other than the predetermined distance, in operation S320, the first computing device 200-1 may obtain direction feature information of the realistic sound, based on the realistic sound information. Herein, the realistic sound information may be the binaural type of sound information measured by the plurality of input units 130 of the first sound device 100-1.

In operation S321, the first computing device 200-1 may obtain first virtual sound information indicating sound generated in a virtual reality game.

In operation S322, the first computing device 200-1 may generate three-dimensional augmented reality sound based on at least one of the realistic sound information, the direction feature information, or the first virtual sound information. In particular, the first computing device 200-1 may generate the three-dimensional augmented reality sound by blending at least one information of the realistic sound information, the direction feature information, or the first virtual sound information.

For example, when the first user 10 has obtained the sound source of the first verse of the national anthem saying that “Until the East Sea's waters and Baekdu Mountain are dry and worn away, God protects and helps us. May our nation be eternal” from the north side of the first user 10, the first computing device 200-1 may generate the three-dimensional augmented reality sound by blending the direction feature information, the realistic sound information, and the first virtual sound information indicating sound generated in the virtual reality game such that the first user 10 can hear the corresponding sound source as if the corresponding sound source has been originated in the north.

In operation S323, the first computing device 200-1 may provide the three-dimensional augmented reality sound to the first user 10 through the first sound device 100-1.

When the first user 10 and the second user 20 are not closer to each other than a predetermined distance, in operation S330, the second computing device 200-2 may obtain location information of the first user 10 and the second user 20.

In operation S331, the first computing device 200-1 may obtain the direction feature information of the realistic sound, based on the location information of the first user 10 and the second user 20. In operation S332, the first computing device 200-1 may obtain the first virtual sound information indicating sound generated in a virtual reality game.

In operation S333, the first computing device 200-1 may generate three-dimensional augmented reality sound based on at least one of the realistic sound information, the direction feature information, or the first virtual sound information. In particular, the first computing device 200-1 may generate the three-dimensional augmented reality sound by blending at least two or more information of the realistic sound information, the direction feature information, or the first virtual sound information.

For example, when the sound source of the first verse of the national anthem saying that “Until the East Sea's waters and Baekdu Mountain are dry and worn away, God protects and helps us. May our nation be eternal” is generated from the second user 20, the first computing device 200-1 may generate the three-dimensional augmented reality sound in consideration of the direction feature information such that the first user 10 located at the right side of the second user 20 can hear the corresponding sound source as if the corresponding sound source has been originated from the left side.

In operation S334, the first computing device 200-1 may provide the three-dimensional augmented reality sound to the first user 10 through the first sound device 100-1.

Above, a method for implementing augmented reality sound is described. However, it will be understood by those skilled in the art that the present disclosure is not limited to implementation of augmented reality sound but may also be substantially identically performed on the implementation of a mixed reality sound including an augmented virtual reality obtained by mixing a reality image with a virtual world image.

In some embodiments, the above-discussed method of FIG. 3 and FIG. 4, according to this disclosure, is implemented in the form of program being readable through a variety of computer means and be recorded in any non-transitory computer-readable medium. Here, this medium, in some embodiments, contains, alone or in combination, program instructions, data files, data structures, and the like. These program instructions recorded in the medium are, in some embodiments, specially designed and constructed for this disclosure or known to persons in the field of computer software. For example, the medium includes hardware devices specially configured to store and execute program instructions, including magnetic media such as a hard disk, a floppy disk and a magnetic tape, optical media such as CD-ROM (Compact Disk Read Only Memory) and DVD (Digital Video Disk), magneto-optical media such as floptical disk, ROM, RAM (Random Access Memory), and flash memory. Program instructions include, in some embodiments, machine language codes made by a compiler compiler and high-level language codes executable in a computer using an interpreter or the like. These hardware devices are, in some embodiments, configured to operating as one or more of software to perform the operation of this disclosure, and vice versa.

A computer program (also known as a program, software, software application, script, or code) for the above-discussed method of FIG. 3 and FIG. 4 according to this disclosure is, in some embodiments, written in a programming language, including compiled or interpreted languages, or declarative or procedural languages. A computer program includes, in some embodiments, a unit suitable for use in a computing environment, including as a stand-alone program, a module, a component, or a subroutine. A computer program is or is not, in some embodiments, correspond to a file in a file system. A program is, in some embodiments, stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program is, in some embodiments, deployed to be executed on one or more computer processors located locally at one site or distributed across multiple remote sites and interconnected by a communication network.

According to the disclosed embodiment, since the three-dimensional augmented reality sound is provided in the proper manner of a binaural scheme or a positioning scheme depending on the distance between users using an augmented reality game, it is possible to implement the three-dimensional augmented reality sound by reflecting realistic sound and virtual sound more realistically in real time.

Furthermore, when a difference between the location of a user using an augmented reality game and the location or movement of the user's avatar occurs, the three-dimensional augmented reality sound may be implemented in consideration of the difference.

Although the exemplary embodiments of the inventive concept have been described with reference to the accompanying drawings, it will be understood by those skilled in the art to which the inventive concept pertains that the inventive concept can be carried out in other detailed forms without changing the technical spirits and essential features thereof. Therefore, the above-described embodiments are exemplary in all aspects, and should be construed not to be restrictive.

What is claimed is:

1. An augmented reality sound implementation system for performing a method for an augmented reality sound, the system comprising:
a first computing device of a first user; and
a first sound device which is worn by the first user such that the first user can receive a three-dimensional augmented reality sound, is connected to the first computing device in a wired or wireless manner, and includes a sound recording function,
wherein the method comprising:
obtaining, by the first sound device, realistic sound information, which indicates a realistic sound, to transmit the realistic sound information to the first computing device;
obtaining, by the first computing device, a first virtual sound which indicates a sound generated from a virtual reality game executed by the first computing device;
generating, by the first computing device, a three-dimensional augmented reality sound based on the realistic sound information and the first virtual sound; and
providing, by the first computing device, the three-dimensional augmented reality sound to the first user through the first sound device.

2. The system of claim 1, wherein the method further comprising:
obtaining, by the first computing device, direction feature information indicating a location where the realistic sound is generated; and
further considering, by the first computing device, the direction feature information to generate the three-dimensional augmented reality sound.

3. The system of claim 2, wherein the first computing device determines whether the first user and a second user spaced apart from the first user are closer than a predetermined distance, and obtains the direction feature information of the realistic sound based on the realistic sound information when the first user and the second user are closer than the predetermined distance, and
wherein the realistic sound information is in a binaural type measured by using a plurality of microphones in the first sound device.

4. The system of claim 2, wherein the first computing device determines whether the first user and a second user spaced apart from the first user are closer than a predetermined distance, and obtains the direction feature information of the realistic sound based on location information of the first user and the second user when the first user and the second user are not closer than the predetermined distance.

5. The system of claim 1, wherein, when a location difference that a relative location in a reality space of the first user and a second user spaced apart from the first user does not correspond to a relative location of an avatar in a virtual space of the first user and the second user occurs, the first computing device generates the three-dimensional augmented reality sound based on the location difference.

6. The system of claim 5, wherein the location difference is a case where the second user and the avatar of the second user are divided, as a case where the second user utilizes a skill to the first user.

7. The system of claim 5, wherein the location difference is a case where movement of the avatar of the second user is greater or shorter than movement of the second user, as a case where the second user utilizes a skill to the first user.

8. The system of claim 5, wherein the three-dimensional augmented reality sound is generated through blending a second virtual sound, which is generated to correspond to a location of the avatar, and the realistic sound.

9. A computer-readable medium recording a program for performing an augmented reality sound implementing method performed by the augmented reality sound implementing system described in claim 1.

10. An application for a terminal device stored in a medium to perform a method for the augmented reality sound performed by the augmented reality sound implementing system coupled to the computing device being hardware, which is described in claim 1.
